(19) United States
(12) Patent Application Publication
(10) Pub. No.: US 2016/0027542 A1
(43) Pub. Date: Jan. 28, 2016

(54) EXTRUSION MOLDING APPARATUS

(71) Applicant: KABUSHIKI KAISHA TOSHIBA, Minato-Ku (JP)

(72) Inventors: Ryota TAKAHASHI, Shinagawa (JP); Shohei KAWANO, Yokohama (JP); Akio SAYANO, Yokohama (JP); Masamichi OBATA, Shinagawa (JP)

(73) Assignee: KABUSHIKI KAISHA TOSHIBA, Minato-Ku (JP)

(21) Appl. No.: 14/806,170

(22) Filed: Jul. 22, 2015

(30) Foreign Application Priority Data
Jul. 22, 2014 (JP) 2014-148749

(51) Int. Cl. G21F 9/30; B28B 3/22; B28B 11/16; B28B 17/02

(52) U.S. Cl. CPC G21F 9/30; B28B 17/02; B28B 3/22; B28B 11/16

(57) ABSTRACT

An extrusion molding apparatus 10 includes: a container 13 that a container 13 into that a kneaded material 12 containing inorganic adsorbent 11 having radionuclides adsorbed thereon is thrown; a mold cavity 14 of a specified shape provided on a wall surface of the container 13; an extrusion unit 16 that is provided inside the container 13 to extrude the kneaded material 12 out of the container 13 through the mold cavity 14; and a hydrogen removal unit 17 that is provided in the container 13 to recombine hydrogen gas 23 generated inside the container 13 and to remove the hydrogen gas 23.

### BACKGROUND OF THE INVENTION

1. Field of the Invention

The present invention relates to an extrusion molding apparatus for use in producing a ceramic solidified body of inorganic adsorbent containing radionuclides.

2. Description of the Related Art

Abolition of a nuclear power plant entails generation of various radioactive wastes (hereinafter simply referred to as “wastes”) in the process of abolition, the wastes being different in radiation levels and in materials.

The method for processing and disposing the wastes depends on the radiation levels and materials of the wastes.

The wastes having high radioactivity, such as nuclear fuels, are reprocessed and then solidified with glass, before being buried underground (geologically disposed).

As for the wastes having low radioactivity, the range of the nuclear levels is widespread.

Among the wastes with low radiation levels, transuranium element wastes (TRans-Uranium) that are in the group of relatively high in radiation level are geologically disposed.

And the wastes in the group of relatively low in low radiation levels are subjected to solidification processing so as to be stored for a long period of time.

For example, in Fukushima Daiichi nuclear power plant, inorganic adsorbent such as zeolite is used to adsorb radionuclides, such as cesium, which are contained in radioactive contamination water. This inorganic adsorbent is subjected to solidification processing and is stored until final disposal.

Methods for fabricating more stable solidified bodies are currently studied for disposal or long-term storage of such inorganic adsorbent.

To understand the background technology, Japanese Patents No. 2807381 and No. 3071513 may be adequate as reference, for example.

In the case of performing solidification processing of the radioactive inorganic adsorbent containing radionuclides, it is not desirable for operators to come close to the site of the operation.

Therefore, the solidification processing needs to be performed by remote control that involves automatic operation or performed while radioactivity is completely blocked.

This necessitates structuring respective members that constitute a manufacturing plant as simple as possible and enhancing abrasion resistance and corrosion resistance so as to suppress frequency of failures and inspections.

In this solidification processing, radiation resolves water and generates hydrogen gas. The amount of hydrogen gas is sometimes too large to ignore.

Therefore, some measures need to be taken to enable automatic operation to be continuously performed even in the situation where such hydrogen gas is generated (for example, see Patent Document 1: Japanese Patent No. 2807381).

The present invention has been made in consideration of such circumstances, and an object of the present invention is to provide an extrusion molding apparatus capable of performing remote-control extrusion molding of a kneaded material which contains radionuclides and generates hydrogen gas.

An extrusion molding apparatus according to the present embodiment includes: a container into that a kneaded material containing inorganic adsorbent having radionuclides adsorbed thereon is thrown; a mold cavity of a specified shape provided on a wall surface of the container; an extrusion unit that is provided inside the container to extrude the kneaded material out of the container through the mold cavity; and a hydrogen removal unit that is provided in the container to remove a hydrogen gas by recombining the hydrogen gas generated inside the container.

According to the present invention, the extrusion molding apparatus is provided which is capable of performing remote-control extrusion molding of the kneaded material which contains radionuclides and generates hydrogen gas.

### BRIEF DESCRIPTION OF THE DRAWINGS

FIG. 1 is a schematic block diagram of an extrusion molding apparatus and peripheral equipment thereof according to a first embodiment;

FIG. 2 is a cross sectional perspective view of the modified example of the molding apparatus according to the first embodiment;

FIG. 3 is a schematic cross sectional view of a molding apparatus according to a second embodiment;

FIG. 4 is a cross sectional perspective view of the modified example of the outer container in the molding apparatus according to the second embodiment;

FIG. 5 is a schematic block diagram of a molding apparatus and peripheral equipment thereof according to a third embodiment; and

FIG. 6 is a schematic cross sectional top view of the molding apparatus according to the third embodiment.

### DESCRIPTION OF THE PREFERRED EMBODIMENT

Hereunder, embodiments of the present invention will be described hereinbelow with reference to accompanying drawings.

### First Embodiment

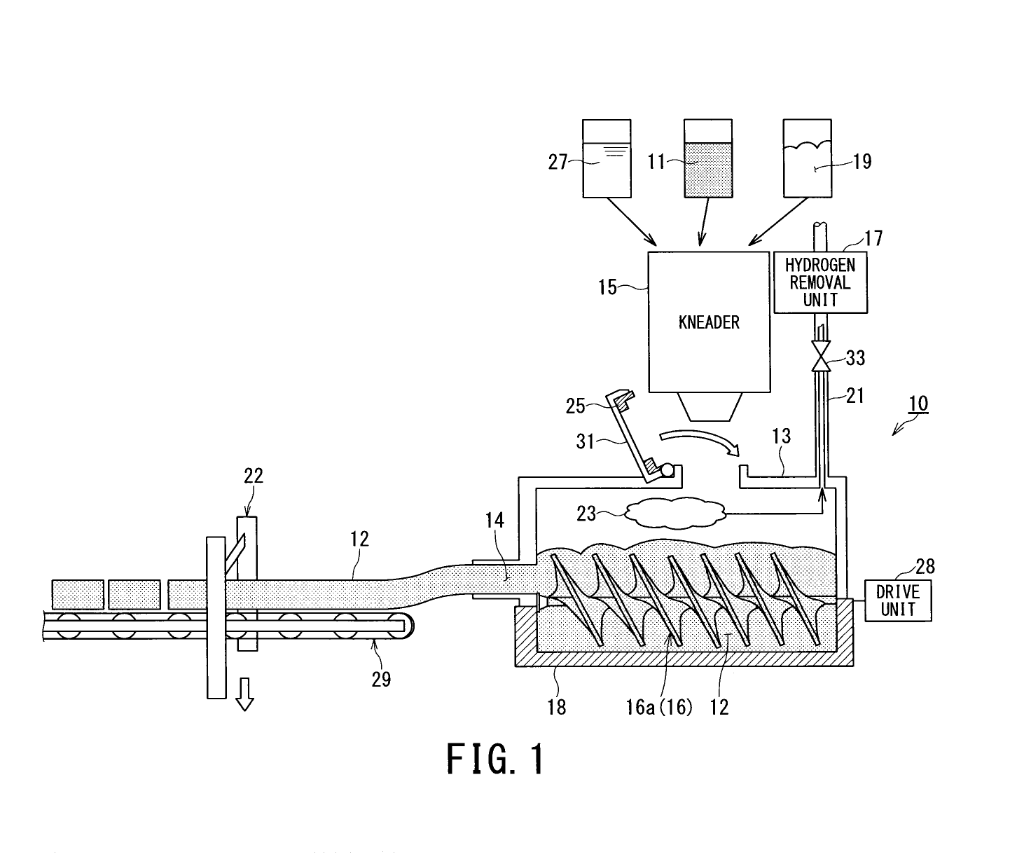

With reference to FIG. 1 showing a schematic block diagram of an extrusion molding apparatus 10 (hereinafter simply referred to as “molding apparatus 10”) and peripheral equipment thereof according to the first embodiment, the molding apparatus 10 according to the first embodiment includes: a container 13 into that a kneaded material 12 containing inorganic adsorbent 11 having radionuclides adsorbed thereon is thrown; a mold cavity 14 of a specified shape provided on a wall surface of the container 13; an extrusion unit 16 that is provided inside the container 13 to extrude the kneaded material 12 out of the container 13 through the mold cavity 14; and a hydrogen removal unit 17 that is provided in the container 13 to recombine hydrogen gas 23 generated inside the container 13 and to remove the hydrogen gas 23.

The container 13 further includes a cooler 18 that cools the kneaded material 12.

The molding apparatus 10 targets the inorganic adsorbent 11 which is, for example, used in an adsorption tower installed in the nuclear power plant.

In the adsorption tower, the inorganic adsorbent 11 is housed in a plurality of vessels connected in series, and adsorbs radionuclides from radioactive contamination water passing through the vessels.

The vessels which sufficiently adsorbed the radionuclides are detached, and the inorganic adsorbent 11 housed therein is processed in the molding apparatus 10.

The inorganic adsorbent 11 is first kneaded together with a molding assistant 19 and water 27 in a kneader 15.

For example, the molding assistant 19 is made of a clay mineral represented by bentonite or kaoline as a main ingredient.

The inorganic adsorbent 11 is kneaded with such a molding assistant 19 and water 27 until it gains proper viscosity and moisture content.

The container 13 contains the kneaded material 12 containing the inorganic adsorbent 11 having the radionuclides adsorbed thereon.

Once the kneaded material 12 is contained, an opening portion of the container 13 is closed by a lid 31.

The lid 31 has a packing 25, so that the container 13 is sealed by closing the lid 31.

A mold cavity 14 of a specified shape is provided on a wall of the container 13.

The extrusion unit 16 is provided inside the container 13 with its top end facing the mold cavity 14.

The extrusion unit 16 is, for example, a screw 16a (16) that is rotated by power applied by a drive unit 28 connected thereto.

The screw 16a rotates with its top end facing the mold cavity 14 so as to extrude the kneaded material 12 out of the container 13 through the mold cavity 14.

The kneaded material 12 may be heated to as high as 100° C. or more due to frictional heat caused by kneading in the kneader 15, frictional heat caused by friction with the screw 16a, decay heat of radionuclides, and the like.

Accordingly, in the molding apparatus 10, the container 13 is equipped with the cooler 18 to cool the container 13 to a temperature of around 50° C.

The cooler 18 may come into contact with the container 13 from the outside and thereby cool the container 13, or may feed cold air into a gas phase part of the container 13 to cool the kneaded material 12.

By cooling the container 13 or the kneaded material 12, deterioration of the container 13 by heat can be prevented, while evaporation of moisture in the kneaded material 12 can be controlled.

The screw 16a and the mold cavity 14, which is rubbed strongly with the kneaded material 12, may preferably be subjected to antiwear and anticorrosion treatment that is to coat the screw 16a and the mold cavity 14 with Inconel, WC coating or the like.

Such treatment can suppress the frequency of repair, inspection, and replacement of the container 13, the screw 16a or the like.

The container 13 includes the hydrogen removal unit 17 to recombine hydrogen gas 23 generated inside the container 13 and to remove the hydrogen gas 23.

For example, the hydrogen removal unit 17 is connected to the inside of the container 13 via a conduit 21. The hydrogen gas 23 flowing in through the conduit 21 is thereby recombined and removed.

Among the plurality of metal oxides of various oxidation numbers, metal peroxide having an oxidation number equal to or more than an oxidation number most stable in the atmosphere is used for the recombination in the hydrogen removal unit 17.

The oxidation number is an indicator of the degree of electron density of a target atom in comparison with the target atom as a simple substance.

For example, tin and chromium are most stable when their oxidation number is +IV and +III, respectively.

In the case of a metal peroxide having an oxidation number higher than such a most stable oxidation number in the atmosphere, the amount of oxygen emitted from the metal peroxide becomes large, which results in efficient progress of an oxidation treatment reaction of hydrogen.

For example, it is preferable to use a peroxide of at least one kind of metal selected from Sc, Ti, V, Cr, Mn, Fe, Co, Ni, Cu, Zn, Y, Zr, Mo, Tc, Ru, Rh, Cd, Hf, Ta, W, Re, Os, Ir, and Pt.

For recombination in the hydrogen removal unit 17, a metal catalyst such as platinum, palladium, or rhodium may be used, and oxygen in the atmosphere may be catalytically hydrogenated.

Instead of providing the hydrogen removal unit 17 outside the container 13, the above-stated metal oxides or metal catalysts such as platinum may be provided on an inner side of a top surface or the like of the container 13.

In this case, these metal catalysts and the like come into contact with the hydrogen gas 23 to oxidize and produce water before the density of the hydrogen gas 23 increases to the level that causes explosion.

The kneaded material 12 is extruded in a bar-like shape through the mold cavity 14 and is discharged onto a conveyor 29. The kneaded material 12 is then cut by a cut unit 22 provided at right angles to the direction of movement of the conveyor 29.

The kneaded material 12 cut into a block shape is dried and then calcinated to be a ceramic solidified body.

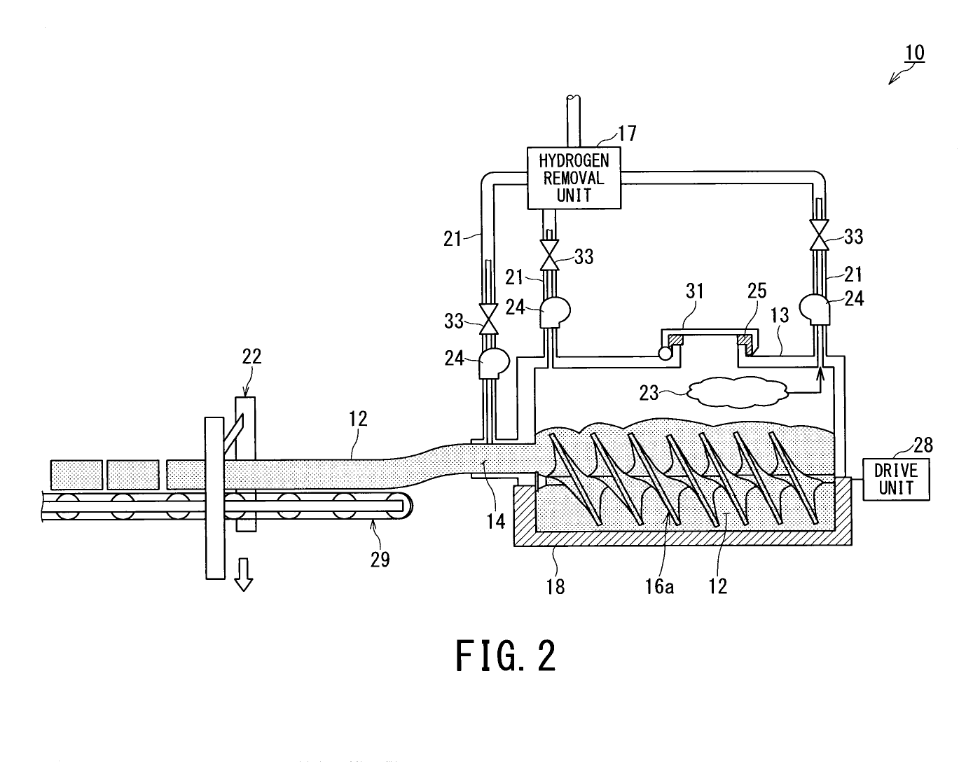

Now, a modified example of the molding apparatus 10 according to the first embodiment will be described with reference to a schematic cross sectional view of FIG. 2.

In FIG. 2, some of those illustrated in FIG. 1 are omitted, such as the kneader 15 and the molding assistant 19.

As described in the foregoing, after the kneaded material 12 is introduced into the container 13, the inside of the container 13 is sealed with the lid 31

When extrusion molding is performed, an exhaust valve 33 is opened, so that the hydrogen gas 23 generated by degradation of moisture in the kneaded material 12 is discharged through the conduit 21.

In the modified example of the molding apparatus 10, the conduit 21 is equipped with a vacuum pump 24.

The vacuum pump 24 sucks gas of a gaseous phase part in the container 13, and reduces pressure inside the container 13 close to vacuum.

Reducing the pressure inside the container 13 in this way can remove air bubbles contained in the kneaded material 12.

By removing air bubbles from the kneaded material 12, a volume of the solidified body formed by calcination of the kneaded material 12 can be reduced, while cracks can be suppressed.

In this case, complete sealability and vacuum property are not essential. This means it is enough if the pressure in the container 13 is reduced to the level that air bubbles can be removed from the kneaded material 12.

To evenly remove air bubbles, a plurality of conduits 21 may be provided as illustrated in FIG. 2.

As described in the foregoing, the molding apparatus 10 according to the first embodiment can perform remote-control extrusion molding of the kneaded material 12 that contains radionuclides and generates the hydrogen gas 23.

### Second Embodiment

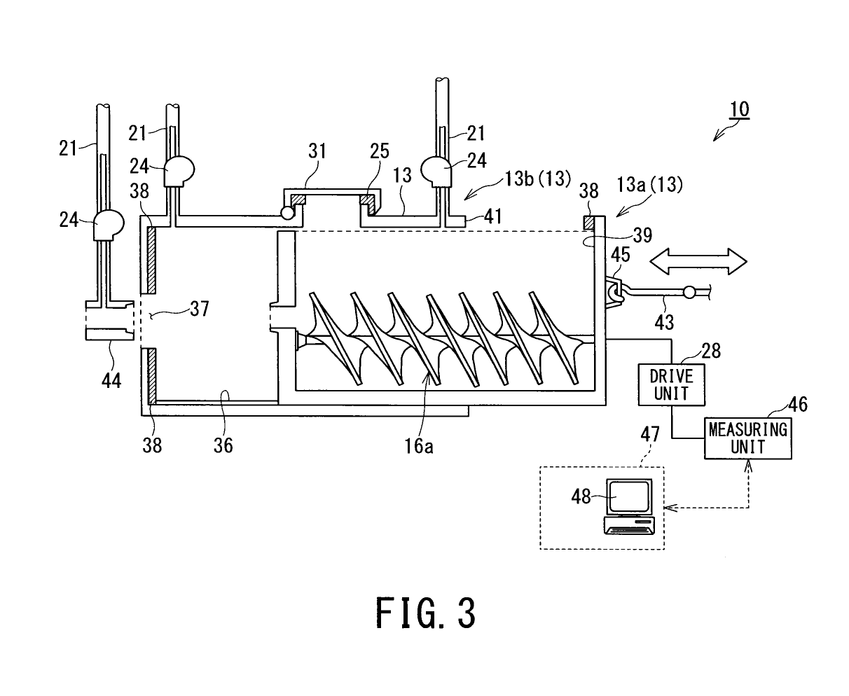

FIG. 3 is a schematic cross sectional view of a molding apparatus 10 according to a second embodiment.

As illustrated in FIG. 3, in the molding apparatus 10 according to the second embodiment, the container 13 comprises two or more detachable members.

As described in the foregoing, the molding apparatus 10 targets the kneaded material 12 that is clayey at relatively high temperature and viscosity. Accordingly, occurrence of failures such as clogging needs to be taken into consideration.

However, since the kneaded material 12 contains radionuclides, it is not desirable for operators to come close to the apparatus even when the failures occur.

Therefore, in the case of minor failures, it is desired to repair the apparatus on site by remote control.

Accordingly, the container 13 is constituted from two or more detachable members to enable one or more robot arm 43 and the like to disassemble the container 13 by remote control to the degree that the container 13 is repairable.

Adopting such structure makes it possible to perform washing or replacement of only a part of the component members.

More specifically, as illustrated in FIG. 3 for example, the container 13 has dual structure constituted of an inner container 13a (13) to which the kneaded material 12 (FIG. 1) is directly introduced and an outer container 13b (13) that contains the inner container 13a. The inner container 13a is drawable along a groove 36 provided on the outer container 13b and is detachable.

For example, one of lateral surfaces of the outer container 13b is open. The inner container 13a is contained in the outer container 13b through the open lateral surface.

The inner container 13a slightly smaller than the outer container 13b is inserted along the groove 36 provided on the outer container 13b at right angles to the open lateral surface.

An upper surface of the inner container 13a is open. When the inner container 13a is contained in the outer container 13b, an upper surface of the outer container 13b serves as a cover to seal the inside of the inner container 13a.

The open lateral surface of the outer container 13b is closed by a lateral surface (hereinafter referred to as “end face 39”) of the inner container 13a, the lateral surface being opposite to a lateral surface where the mold cavity 14 is provided.

A sealing material 38 is placed in a peripheral portion of a mouth ring connecting hole 37 of the outer container 13b or in a contacting portion and the like between an opening edge 41 of the outer container 13b and the end face 39. As a result, sealing performance of the container 13 is enhanced.

A handle 45 is provided on the end face 39. For example, a robot arm 43 is attached to this handle 45 to pull out the inner container 13a.

Furthermore, the mouth ring 44 is also detachable from the inner container 13a, which facilitates disassembly of the container 13.

The drive unit 28 connected to the screw 16a (rotating body 16a) is connected to a measuring unit 46 that measures a torque value of the screw 16a.

The torque value measured by the measuring unit 46 is monitored, for example, by a monitor 48 in a central control room 47.

When the measured torque value exceeds a specified threshold value, it is determined that some failure occurs in the molding apparatus 10, and the drive unit 28 stops operation.

Then, as described in the foregoing, the robot arm 43 is used to disassemble the container 13 by remote control as and when required.

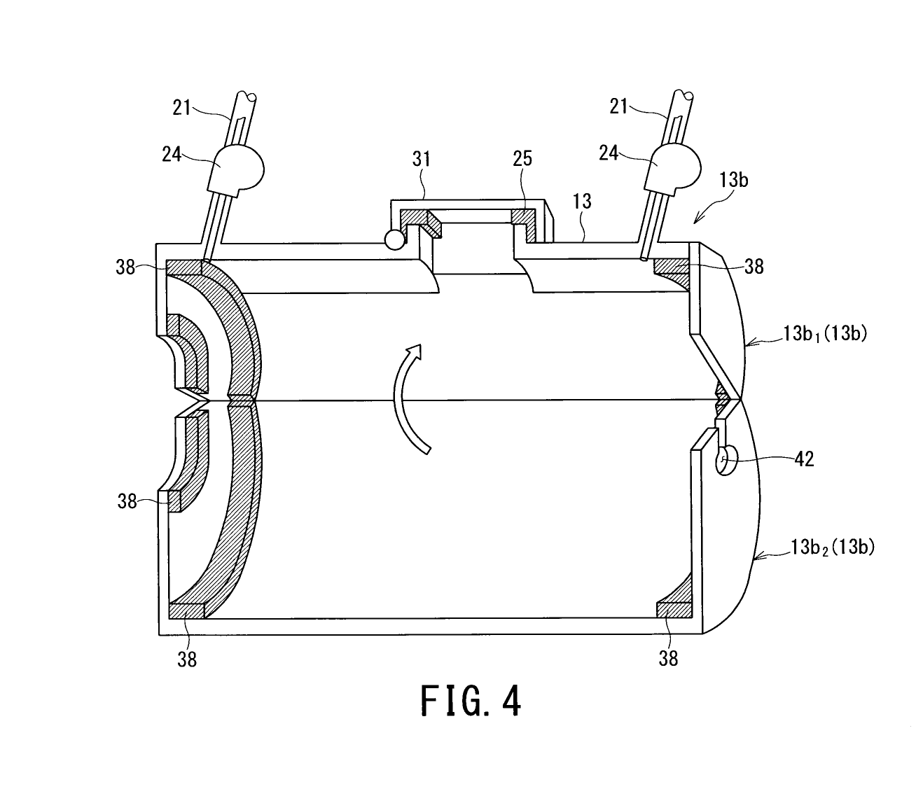

Now, a modified example of the outer container 13b will be described with reference to FIG. 4.

FIG. 4 is a cross sectional perspective view of the modified example of the outer container 13b in the molding apparatus 10 according to the second embodiment.

As illustrated in FIG. 4, the container 13 may have dual structure constituted of an inner container 13a that directly contains the kneaded material 12 and an outer container 13b that contains the inner container 13a. A part of the outer container 13b may open and close.

The outer container 13b is constituted of a top cover 13b1 and a main body portion 13b2.

The top cover 13b1 and the main body portion 13b2 are engaged with each other via a hinge. The inner container 13a is taken out by opening the top cover 13b1.

On a lateral surface of the main body portion 13b2, a line hole 42 is provided which has the shape of a keyhole with a cut line extending to an upper edge portion of the main body portion 13b2.

Through the line hole 42, a line of the drive unit 28 can be taken out of the outer container 13b while being connected to the inner container 13a.

Thus, according to the second embodiment, it becomes easy to repair, wash, or partially replace the molding apparatus 10 by remote control.

Since the second embodiment is similar in structure and operation procedures to the first embodiment except that the container 13 is constituted of a plurality of detachable members and the torque value is measured to monitor failures of the molding apparatus 10, redundant description is omitted.

Also in the drawings, the portions having common structure or functions are designated by identical reference numerals to omit redundant description.

Thus, the molding apparatus 10 according to the second embodiment can implement the effect of the first embodiment. In addition, since the molding apparatus 10 can easily be disassembled, it becomes easy to perform repair, washing, or partial replacement by remote control.

Furthermore, monitoring the torque value makes it possible to remotely ascertain when to perform such repair, washing, or partial replacement.

### Third Embodiment

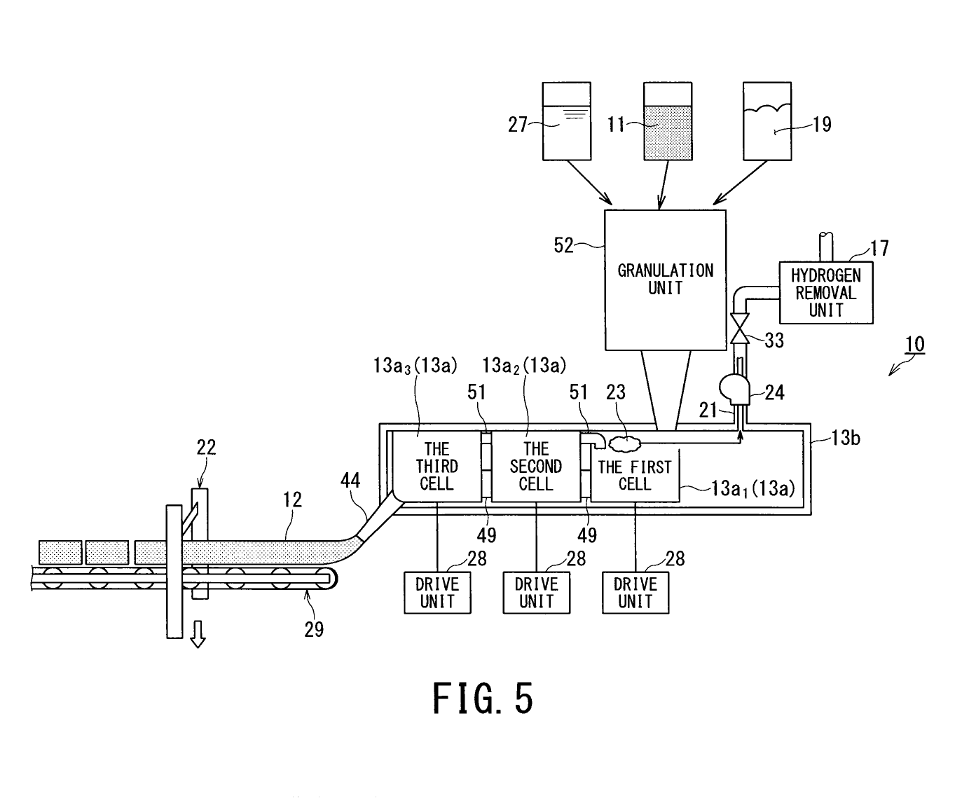

FIG. 5 is a schematic block diagram of a molding apparatus 10 and peripheral equipment thereof according to a third embodiment.

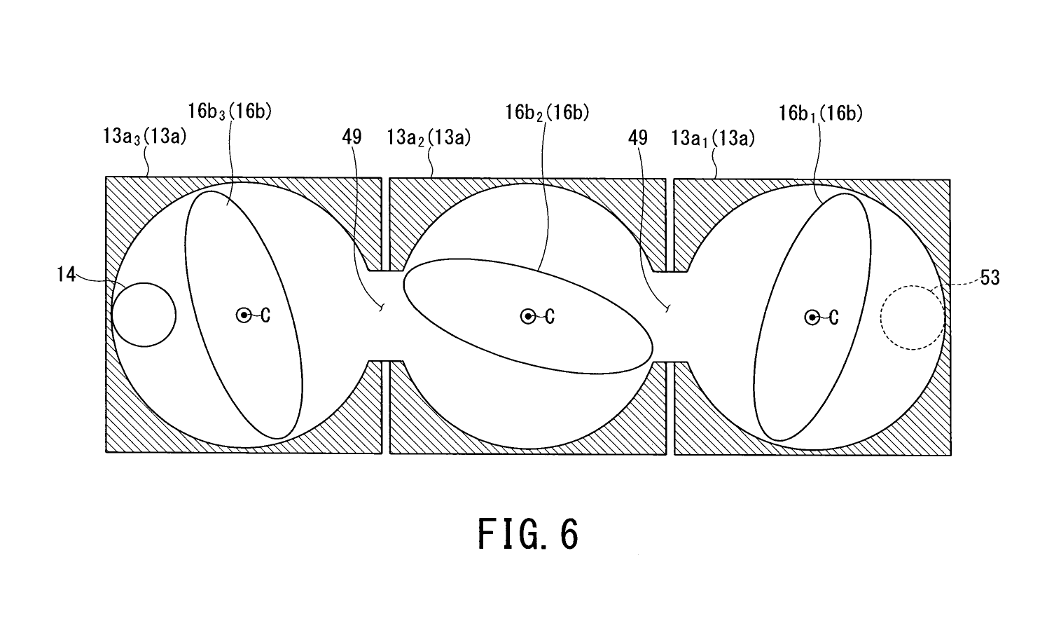

FIG. 6 is a schematic cross sectional top view of the molding apparatus 10 according to the third embodiment.

In the molding apparatus 10 according to the third embodiment as illustrated in FIG. 5, the inner container 13a is divided into a plurality of cells 13a having a rotor 16b provided inside, the rotor having an axis of rotation C perpendicular to the mold cavity 14. An inside of the cell 13aₙ (n=1, 2, 3) communicates with an inside of another adjacent cell 13aₖ (k≠n).

The kneader 15 is replaced with a granulation unit 52 that needs and granulates the kneaded material 12 into particles with a particle diameter of about several millimeters to several centimeters.

An upper surface of each of the cells 13aₙ (n=2, 3) is open. When the cells 13aₙ are contained in the outer container 13b, an upper surface of the outer container 13b serves as a cover to seal the cells 13aₙ.

However, the first cell 13a₁ connected to the granulation unit 52 is not sealed by the upper surface of the outer container 13b, so that generated hydrogen gas 23 can freely be released to the outside of the first cell 13a₁.

The second cell 13a₂ is placed closer to a mouth ring side than the first cell 13a₁, and the inside of the second cell 13a₂s is connected to the inside of the first cell 13a₁ through a connection port 49.

The third cell 13a₃ is placed closer to the mouth ring side than the second cell 13a₂, and the inside of the third cell 13a₃ is connected to the inside of the first cell 13a₁ through the connection port 49 and is also connected to the mouth ring 44.

A hydrogen port 51 connects between the first cell 13a₁ and the second cell 13a₂ and between the second cell 13a₂ and the third cell 13a₃ at a position higher than the connection port 49.

The hydrogen port 51 is provided so that the hydrogen gas 23 generated in the respective cells 13aₙ can flow across the respective cells 13aₙ.

Since the hydrogen gas 23 stagnates in an upper portion of the cells 13aₙ due to its specific gravity, the hydrogen port 51 is preferably provided at a highest possible position on a lateral surface of the cells 13aₙ.

From a viewpoint of preventing the hydrogen port 51 from being closed by the kneaded material 12 which is scattered by rotation of the rotor 16b, the hydrogen port 51 is preferably provided at a highest possible position.

The outer container 13b has a conduit 21 provided to be connected to a space portion that communicates with the inside of the first cell 13a₁.

The conduit 21 is equipped with a vacuum pump 24 and a hydrogen removal unit 17, so that the pressure inside the outer container 13b is reduced and the hydrogen gas 23 is removed.

Since the inside of the outer container 13b communicates with the inside of the first cell 13a₁, the pressure reduction processing and hydrogen removal processing also achieve pressure reduction and hydrogen removal inside the first cell 13a₁.

Next, a molding method in a third embodiment will be described with reference to FIG. 6 (see FIG. 5 accordingly).

First, in the granulation unit 52, the inorganic adsorbent 11, the molding assistant 19, and the water 27 are kneaded into a kneaded material 12, and the kneaded material 12 is granulated to particles of about several millimeters to several centimeters.

Then, the granular kneaded material 12 is supplied to a supply spot 53 in the first cell 13a₁.

In the first cell 13a₁, the granulated kneaded material 12 is pulverized by a rotor 16b₁.

The pulverized kneaded material 12 is discharged to the second cell 13a₂ through the connection port 49.

In the second cell 13a₂, the kneaded material 12 is further kneaded by a rotor 16b₂ to increase viscosity to the level necessary for extrusion molding. The kneaded material 12 is then discharged to the third cell 13a₃ through the connection port 49.

In the third cell 13a₃, a rotor 16b₃ is further used to extrude the kneaded material 12 through the mold cavity 14.

Thus, in the third embodiment, the conduit 21 is placed in the vicinity of the first cell 13a₁ that contains the granular kneaded material 12 low in viscosity, so that clogging of the conduit 21 caused by the kneaded material 12 can be prevented.

Since the third embodiment is similar in structure and operation procedures to the first embodiment except in the structure of preventing clogging of the conduit 21 caused by the kneaded material 12, redundant description will be omitted.

Also in the drawings, the portions having common structure or functions are designated by identical reference numerals to omit redundant description.

The kneader 15 may be replaced with a mixing unit instead of the granulation unit 52.

The inorganic adsorbent 11, the molding assistant 19, and the water 27 are supplied to the mixing unit at a specified ratio as in the case of the kneader 15 described in the first embodiment.

However, the mixture is introduced to the first cell 13a₁ without being fully kneaded as compared with the kneader 15.

In this case, the mixture in the first cell 13a₁ does not have sufficient viscosity, so that it is unlikely that the mixture is sucked to the conduit 21 placed in the vicinity of the first cell 13a₁ and causes clogging of the conduit 21.

Thus, the molding apparatus 10 according to the third embodiment can implement the effect of the first embodiment, and in addition, the molding apparatus 10 can prevent clogging of the conduit 21 caused by the kneaded material 12 being sucked to the conduit 21 during removal of the hydrogen gas 23 or pressure reduction.

In the molding apparatus 10 according to at least one of the embodiments described above, the container 13 is equipped with the conduit 21 and the hydrogen removal unit 17, so that remote-control extrusion molding of the kneaded material 12 that contains radionuclides and generates the hydrogen gas 23 can be performed.

It is further to be noted that although some embodiments of the present invention have been described, these embodiments are in all respects illustrative and are not considered as the basis for restrictive interpretation.

It should be understood that these embodiments can be performed in other various forms and that various removals, replacements, modifications, and combinations are possible without departing from the meaning of the present invention.

These embodiments and their modifications are intended to be embraced in the range and meaning of the present invention, and particularly are intended to be embraced in the invention disclosed in the range of the claims and the equivalency thereof.

1. An extrusion molding apparatus, comprising:
a container into that a kneaded material containing inorganic adsorbent having radionuclides adsorbed thereon is thrown;
a mold cavity of a specified shape provided on a wall surface of the container;
an extrusion unit that is provided inside the container to extrude the kneaded material out of the container through the mold cavity; and
a hydrogen removal unit that is provided in the container to remove a hydrogen gas by recombining the hydrogen gas generated inside the container.

2. The extrusion molding apparatus according to claim 1, wherein
the hydrogen removal unit is connected to an inside of the container via a conduit so as to recombine the hydrogen gas flowing in through the conduit.

3. The extrusion molding apparatus according to claim 1, wherein
among the plurality of metal oxides of various oxidation numbers, a metal peroxide having an oxidation number equal to or more than an oxidation number most stable in an atmosphere is used for the recombination in the hydrogen removal unit.

4. The extrusion molding apparatus according to claim 1, wherein
a metal catalyst is used for the recombination in the hydrogen removal unit.

5. The extrusion molding apparatus according to claim 1, wherein
the container includes a cooler that cools at least one of the kneaded material and the container.

6. The extrusion molding apparatus according to claim 1, wherein
the container comprises two or more detachable members.

7. The extrusion molding apparatus according to claim 6, wherein
the container has dual structure constituted of an inner container that directly contains the kneaded material and an outer container that contains the inner container, and
the inner container is drawable along a groove provided on the outer container and is detachable.

8. The extrusion molding apparatus according to claim 6, wherein
the container has dual structure constituted of an inner container that directly contains the kneaded material and an outer container that contains the inner container, and
the inner container is detached and attached as a part of the outer container is opened and closed.

9. The extrusion molding apparatus according to claim 1, wherein
the extrusion unit is a rotating body that extrudes the kneaded material through the mold cavity while rotating, and
the rotating body includes a measuring unit that measures a torque value of the rotating body.

10. The extrusion molding apparatus according to claim 1, wherein
the mold cavity and the extrusion unit are coated with one of Inconel and WC coating, respectively.

11. The extrusion molding apparatus according to claim 2, wherein
the conduit includes a vacuum pump that sucks gas of a gaseous phase part in the container to reduce pressure inside the container close to vacuum.

12. The extrusion molding apparatus according to claim 7, wherein
the inner container is divided into a plurality of cells having a rotor provided inside, the rotor having an axis of rotation perpendicular to the mold cavity, and
an inside of each of the cells communicates with an inside of another adjacent cell.
